(19) United States
(12) Patent Application Publication
(10) Pub. No.: US 2021/0325905 A1
(43) Pub. Date: Oct. 21, 2021

(54) COORDINATED LABOR ACTIVITIES USING DRONES

(71) Applicant: eConnect, Inc., Las Vegas, NV (US)

(72) Inventors: Henry Valentino, III, Las Vegas, NV (US); Jack Coronel, Las Vegas, NV (US); Malcolm Rutherford, Las Vegas, NV (US); Rick Lopez, Las Vegas, NV (US)

(21) Appl. No.: 17/143,952

(22) Filed: Jan. 7, 2021

Related U.S. Application Data
(63) Continuation of application No. PCT/US19/40886, filed on Jul. 8, 2019.
(60) Provisional application No. 62/695,629, filed on Jul. 9, 2018.

(51) Int. Cl. G05D 1/10; A47L 1/02; B08B 1/00; H04W 4/40; B64C 39/02

(52) U.S. Cl. CPC G05D 1/104; A47L 1/02; B08B 1/001; B64C 2201/145; B64C 39/024; B64C 2201/12; H04W 4/40

(57) ABSTRACT

Technologies and implementations for coordinating a number of drones including facilitating management of the drones during performance of a service. The management of the drones facilitated by having one of the drones execute a supervisor program to supervise the drones during the performance of the service.

### RELATED APPLICATION

This application claims benefit of priority to U.S. Provisional Patent Application Ser. No. 62/695,629, filed on Jul. 9, 2018, titled COORDINATED LABOR ACTIVITIES USING DRONES. The U.S. Provisional Patent Application Ser. No. 62/695,629 is incorporated herein by reference in its entirety.

### INFORMATION

Unless otherwise indicated herein, the approaches described in this section are not prior art to the claims in this application and are not admitted to be prior art by inclusion in this section.

Vehicles that do not have a person on board operating the vehicle may include several types of vehicles (e.g., “unmanned”). One example of an unmanned vehicle may be an Unmanned Air Vehicle (UAV). A UAV may include a variety of vehicles (e.g., some semi-autonomous and some autonomous). For example, some UAVs used by the military may be semi-autonomous because a user (e.g., a pilot) may remotely control the UAV. Some UAVs, which may be commonly available to the public consumer, may be semi-autonomous because these UAVs may be wirelessly controlled by a user using a remote control having various toggles and switches. These examples of UAVs commonly require constant user control, albeit remotely.

Some UAVs may be autonomous, and accordingly, may not require constant user control. These UAVs may be commonly referred to as “drones”. An example of a drone may be a UAV that may be programmed to fly to a predetermined location (and/or return from the predetermined location) without the need of a user controlling the UAV during flight. Some of the technology that may help facilitate the use of a drone may include Global Positioning System (GPS), various types of lithium ion batteries as power sources (e.g., Li-ion, LiFePO4, LiPo, etc.), improved computer processing power (e.g., ARM, Intel, NVIDIA, etc.), lightweight material (e.g., carbon fiber, Kevlar, etc.), and so forth. One or more of these technologies may facilitate utilization of UAVs both autonomous and semi-autonomous UAVs.

Even though autonomous UAVs may be more commonly referred to as “drones”, it may be noted that the term “drones” may be used to refer to both semi-autonomous and to autonomous UAVs. Accordingly, hereon out, the term “drone” or “drones” may include autonomous and/or semi-autonomous UAVs.

Drones are becoming more prevalent from military applications, surveillance applications, delivery applications, and so forth to perform various tasks. Commonly, drones may be employed as a single vehicle to perform various tasks. However, as drones are becoming more sophisticated with the inclusion of various technologies, more than one drone may be utilized to perform various tasks. For example, several drones flew in patterns to form various images during the 2018 Winter Olympics held in Pyeongchang, South Korea.

As in Pyeongchang, several drones may be employed to perform various tasks and/or services. However, coordinating several drones for performing these tasks and/or services may be difficult and complicated. Additionally, remotely monitoring and managing the drones during the performance of these tasks and/or services may be difficult including attempting to confirm that the tasks and/or services have been performed to predetermined standards. Additionally, should one or more of the drones malfunction or not perform its specified task or service, it would be difficult to correct and/or compensate for the malfunctioning drone.

### SUMMARY

Described herein are various illustrative methods for coordinating a plurality of drones. Example methods may include a receiving an indication of a request for a service to be performed by the plurality of drones, and responsive to the received indication, activating a coordination protocol for the plurality of drones based, at least in part, on the service to be performed by the plurality of drones. The method may include responsive to the activation of the coordination protocol, determining if each of at the plurality of drones are fitted with an appropriate service module based, at least in part, on the service to be performed, the appropriate service module configured to be utilized for the service to be performed. The method further includes if it is determined that each of the plurality of drones are fitted with the appropriate service module, designating one of the plurality of drones to execute a supervisor program, the supervisor program configured to facilitate management of the rest of the plurality of drones during the performance of the service. Additionally, the method may include launching the plurality of drones, including the designated one of the plurality of drones towards a direction of the service to be performed, the direction of the service to be performed being determined by geographical data.

The present disclosure also describes various example machine readable non-transitory medium having stored therein instructions that, when executed by one or more processors, operatively enable coordination of a drone coordination module (DCM) to receive an indication of a request for a service to be performed by the plurality of drones. Responsive to the received indication, activate a coordination protocol for the plurality of drones based, at least in part, on the service to be performed by the plurality of drones. The DCM may responsive to the activation of the coordination protocol, determine if each of the plurality of drones are fitted with an appropriate service module based, at least in part, on the service to be performed, the appropriate service module configured to be utilized for the service to be performed. The DCM may, if it is determined that each of the plurality of drones are fitted with the appropriate service module, designate one of the plurality of drones to execute a supervisor program, where the supervisor program may be configured to facilitate management of the rest of the plurality of drones during the performance of the service. Additionally, the DCM may be configured to launch the plurality of drones, including the designated one of the plurality of drones towards a direction of the service to be performed, the direction of the service to be performed being determined by geographical data.

The present disclosure additionally describes example systems. Example systems may include a processor, a drone communicatively coupled to the processor, a storage medium communicatively coupled to the processor, and a drone coordination module (DCM) communicatively coupled to the processor and the storage medium. The DCM may be configured to receive an indication of a request for a service to be performed by the plurality of drones. Responsive to the received indication, activate a coordination protocol for the plurality of drones based, at least in part, on the service to be performed by the plurality of drones. The DCM may responsive to the activation of the coordination protocol, determine if each of the plurality of drones are fitted with an appropriate service module based, at least in part, on the service to be performed, the appropriate service module configured to be utilized for the service to be performed. The DCM may, if it is determined that each of the plurality of drones are fitted with the appropriate service module, designate one of the plurality of drones to execute a supervisor program, where the supervisor program may be configured to facilitate management of the rest of the plurality of drones during the performance of the service. Additionally, the DCM may be configured to launch the plurality of drones, including the designated one of the plurality of drones towards a direction of the service to be performed, the direction of the service to be performed being determined by geographical data.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure, and are therefore, not to be considered limiting of its scope. The disclosure will be described with additional specificity and detail through use of the accompanying drawings.

In the drawings:

FIG. 1 illustrates coordination of a number of drones, in accordance with various embodiments;

FIG. 2 illustrates a drone, in accordance with various embodiments;

FIG. 3 illustrates an operational flow diagram for coordinating a number of drones, in accordance with various embodiments;

FIG. 4 illustrates an example computer program product, arranged in accordance with at least some embodiments described herein; and

FIG. 5 is an illustration of a block diagram of an example computing device, all arranged in accordance with at least some embodiments described herein.

### DETAILED DESCRIPTION

The following description sets forth various examples along with specific details to provide a thorough understanding of claimed subject matter. It will be understood by those skilled in the art that claimed subject matter might be practiced without some or more of the specific details disclosed herein. Further, in some circumstances, well-known methods, procedures, systems, components and/or circuits have not been described in detail, to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, systems and computer readable media related to coordination of a number of drones for performing various tasks and/or services.

Drones and their uses were not readily known. However, advancement in various technologies have facilitated an increase in the use of drones to perform various tasks and/or services for both the military and the public. For example, some drones may be used to perform military tasks such as, but not limited to, surveillance and combat tasks. In another example, some drones may be used to perform news related tasks such as, but not limited to, video capturing a news anchor. In yet another example, some drones may be used to perform geographical surveying tasks such as, but not limited to, surveying a town. Some drones may be used to perform delivery tasks such as, but not limited to, delivery of packages. As may be appreciated, drones may be used to perform a wide variety of tasks and/or services. As in human related tasks and/or services, if more than one drone is used, coordinating more than one drone may be difficult and complicated, and in particular, if the drones are to be used to perform a specific task and/or service.

In order to provide a thorough understanding of the disclosed subject matter, a non-limiting example scenario may be described as a utilization of the various embodiments disclosed herein. In the non-limiting example scenario, a number of drones may be utilized to perform a task and/or service, such as, but not limited to washing windows of a multi-story building.

In this example, a company may employ a number of drones to be located in a particular geographic location such as, but not limited to, Las Vegas, Nev. The tasks and/or services to be performed by the drones may be to wash the windows of a building. Continuing with this scenario, the company may receive a request to wash the outside of the windows of a 5-story building in Las Vegas. The request may be communicated to the drones, and in turn, the drones may activate a coordination protocol for the drones to perform the washing of the widows. As part of the coordination protocol, it may be confirmed that the drones are outfitted to wash windows. For example, the drones may need to have the proper attachment/equipment for washing windows (e.g., liquid sprayer, squeegee, sponge, etc.). If the drones are fitted with the appropriate attachment/equipment for the task and/or service to be performed, one of the drones may be designated to take on a supervisor role for the service. The designation may be as part of a command to execute a supervisor role module. At this point, the drones may be launched towards the 5-story building to perform the service.

It may be noted here that the number of drones may vary based, at least in part, on the task and/or service to be performed. For example, the number of drones required to wash the windows of the 5-story building may be different from the number of drones required to wash the windows of a 20-story building. Of course, the total surface area of the windows may affect the number of drones as well (e.g., a 5-story building having 20 windows and a 20-story building having 10 windows).

Continuing with this non-limiting example scenario, the drones may be programmed to fly in the direction of the 5-story building via some geographic data of the city of Las Vegas. Once the drones are on the site of the 5-story building, the drones may have data that may provide dimensional information of the 5-story building including location of the windows and its dimensions.

The drones may proceed to wash the windows of the 5-story building. For example, one drone may spray a window with washing liquid, another drone may scrub the window, and another drone may use a squeegee to remove the washing liquid. In another example, a drone may have the capabilities of performing all of the previous tasks (e.g., wash, scrub, and remove).

The drone designated as the supervisor (here on out, supervisor drone) may perform various supervisory type roles. For example, the supervisor drone may determine if the window is clean (e.g., streaking, residue, still dirty, etc.). Additionally, the supervisor drone may monitor the other drones for any issues such as, but not limited to, mechanical and/or electrical malfunction (e.g., a propeller break, motor malfunction, battery drain, not performing the proper task, etc.). The supervisor drone may be configured to be capable of jumping in and completing tasks and/or services that another drone was not able to complete (e.g., drone malfunction). As the task and/or service completed, the supervisor drone may be configured to ensure that the task was completed appropriately (e.g., windows have been cleaned, work site is clean with no debris from the drones, no malfunctioned drones, etc.).

Once the task and/or service is completed and verified by the supervisor drone, the drones may be configured to fly back to the company. Here again, the supervisor drone may be the last to leave the 5-story building and take one last flight around the building to ensure that the task and/or service has been completed prior to leaving for the company.

The activities described in the above scenario may be facilitated by various technologies including artificial intelligence (AI) (e.g., AI implemented as a basis for the supervisor program). Additionally, the AI may facilitate a degree of autonomy by the drones, and in particular, the supervisor drone to take various actions to fulfill the required task and/or service. Some additional technology that may help facilitate the use of a drone may include Global Positioning System (GPS), various types of lithium ion batteries as power sources (e.g., Li-ion, LiFePO4, LiPo, etc.), improved computer processing power (e.g., ARM, Intel, NVIDIA, etc.), lightweight material (e.g., carbon fiber, Kevlar, etc.), and so forth. One or more of these technologies may facilitate utilization of UAVs both autonomous and semi-autonomous UAVs.

As illustrated in the non-limiting example scenario, a number of drones may be coordinated to perform a task and/or service as implemented by the various embodiments and examples disclosed herein. As a result, in the various embodiments described herein may be provided for an intelligent and autonomous coordination of a number of drones to perform various tasks and/or services.

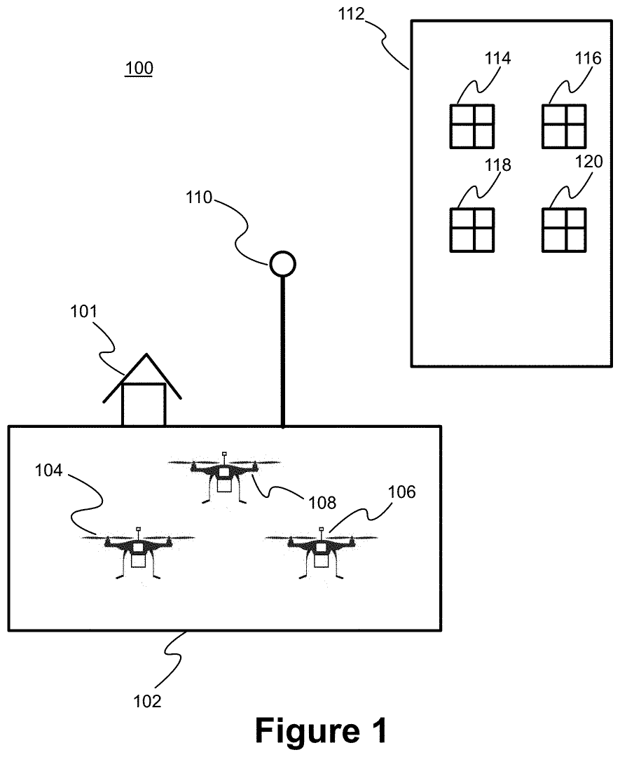

FIG. 1 illustrates coordination of a number of drones, in accordance with various embodiments. In FIG. 1, a system 100 may include a base station 101 may include a UAV staging area 102 (here on out, landing pad). As shown, the landing pad 102 may have a number of UAVs 104, 106, and 108 (here on out, drones) stationed on the landing pad 102. The base station 101 may include a wireless communication system 110. Additionally, in FIG. 1, a building 112 is shown having a number of windows 114, 116, 118, and 120. In the example shown in FIG. 1, the building 112 may be a high-rise type building having multiple floors. As described with respect to the above non-limiting example scenario, a service for cleaning of the windows 114, 116, 118, and 120 of the building 112 may be the task and/or service to be performed by the drones 104, 106, and 108.

Continuing with the example scenario, in FIG. 1, an indication of a request for a service to be performed by the drones 104, 106, and 108 may be received by the base station 101 (e.g., request for cleaning of the windows 114, 116, 118, and 120). The base station 101 may relay the request to the drones 104, 106, and 108. In response to the received indication, the drones 104, 106, and 108 may activate a coordination protocol. The coordination protocol may be based, at least in part, on the service to be performed by the drones 104, 106, and 108 (e.g., cleaning of the windows 114, 116, 118, and 120). In the one example shown, the coordination protocol may be received wirelessly by the drones 104, 106, and 108 via the wireless communication system 110. Accordingly, the drones 104, 106, and 108 may be configured to have wireless communication capabilities.

Responsive to the activation of the coordination protocol, it may be determined if each of the drones 104, 106, and 108 are fitted with the appropriate service module. The appropriate service module may be based, at least in part, on the service to be performed (e.g., cleaning of the windows 114, 116, 118, and 120). As in the previous example, the appropriate service module may include window cleaning related products such as, but not limited to, cleaning liquid, squeegee, and the like. If the drones are fitted with the appropriate service module, one of the drones 104, 106, and 108 may be designated as a supervisor drone (e.g., a message may be transmitted to the drone 104 to execute a supervisor program or the drone may execute the supervisor program on its own as will be described). The supervisor program may be configured to facilitate management of the rest of the drones 106 and 108 by the drone 104 (here on out, supervisor drone). The supervisor drone 104 may perform as a supervisor of the other drones 106 and 108 as previously described above.

Once the drones 104, 106, and 108 (supervisor drone 104) are ready to perform the requested service, the drones 104, 106, and 108 (supervisor drone 104) may launch towards the building 112. The drones 104, 106, and 108 may have geographical data for their flight to the building 112. Additionally, once the drones 104, 106, and 108 have arrived at the building 112, the drones may have dimensional data for the building 112 such as, but not limited to, the location and size of the windows 114, 116, 118, and 120.

The drones 104, 106, and 108 (supervisor drone 104) may proceed to perform the task/service requested (e.g., clean the windows 114, 116, 118, and 120 of the building 112). During the execution of the task and/or service, the supervisor drone 104 may be configured to ensure that the windows 114, 116, 118, and 120 are being cleaned appropriately (e.g., streaking, residue, still dirty, etc.). Subsequently, once the drones 104, 106, and 108 (supervisor drone 104) have completed their task/service, the supervisor drone 104 may confirm that the task/service was performed to a predetermined level such as, but not limited to, windows being clean, work site being clean with no debris from the drone activities, no malfunctioned drones or drone parts, etc.). Finally, after the completion of the task/service, the drones 104, 106, and 108 (supervisor drone 104) may fly back to the base station 101 and land on landing pad 102. Accordingly, an intelligent and autonomous coordination of a number of drones to perform various tasks/services may be facilitated.

In one example, as part of determining if each of the drones 104, 106, and 108 are fitted with an appropriate service module, each of the drones 104, 106, and 108 may perform a self-diagnostic check such as, but not limited to, one or more of a battery level check, a mechanical check, or an electronic system check. In another example, if each of the drones 104, 106, and 108 are not fitted with the appropriate service module (e.g., material for window cleaning), the base station 101 may transmit the request for service to an alternate base, where the drones may be fitted with the appropriate service module based, at least in part on, the service to be performed. In yet another example, if each of the drones 104, 106, and 108 are not fitted with the appropriate service module (e.g., material for window cleaning), a request for a changeout of the service module to the appropriate service module may be transmitted to a facilitator of the changeout (e.g., management to the management of the base 100).

In accordance with various embodiments, drones 104, 106, and 108 may be configured to perform the required tasks/services autonomously (i.e., without substantial human interaction/control). For example, once the drones 104, 106, and 108 have been launched, the drones 104, 106, and 108 may be configured to perform the tasks/services (e.g., cleaning the windows 114, 116, 118, and 120 of the building 112) without a human controlling the drones 104, 106, and 108. However, if necessary, a human may intercede with the performance of the task/service via some form of wireless communication (e.g., a user operating an application on smartphone or a computer).

It should be appreciated by one of ordinary skilled in the relevant art that a wide variety of AI capable processors may be utilized to facilitate at least some of the functionality described herein such as, but not limited to, AI capable processors available from Intel Corporation of Santa Clara, Calif. (e.g., Nervana™ type processors), available from Nvidia Corporation of Santa Clara, Calif. (e.g., Volta™ type processors), available from Apple Company of Cupertino, Calif. (e.g., A11 Bionic™ type processors), available from Huawei Technologies Company of Shenzen, Guangdong, China (e.g., Kirin™ type processors), available from Advanced Micro Devices, Inc. of Sunnyvale, Calif. (e.g., Radeon Instinct™ type processors), available from Samsung of Seoul, South Korea (e.g., Exynos™ type processors), and so forth, and accordingly, the claimed subject matter is not limited in these respects. The utilization of AI capable processors may facilitate the activities of the supervisor drone 104 as described.

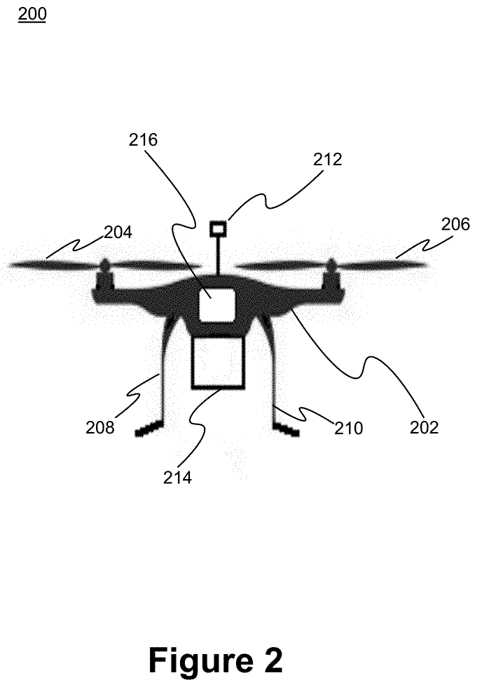

Turning now to FIG. 2, which illustrates an example drone, in accordance with various embodiments. In FIG. 2, a frontal planar view a drone 200 may comprise a body 202 and may have one or more rotors 204 and 206. Additionally, the drone 200 may have one or more legs 208 and 210 and an antenna 212 coupled to the body 202. Shown in this example, the drone 200 may have a service module 214 coupled to the body 202. As shown, the body 202 may include an electronic system module 216. The drone 200 may be utilized to perform various tasks/services, in accordance with various embodiments of the claimed subject matter.

It should be appreciated that the drone 200 shown in FIG. 2 is a simplified illustration of a drone, and accordingly, the drone 200 may have various configurations without departing from the scope and spirit of the disclosure. For example, the drone 200 may have a single rotor or multiple rotors, the body 202 may have a wide variety of shapes (e.g., substantially rectangular, substantially circular, substantially oval, and so forth), the drone 200 may or may not have the legs 208 and 210, and the antenna 212 may be incorporated in the body 202 or the drone 200 may not include an antenna. Additionally, the drone 200 may have the service module 214 coupled in a variety of manners such as, but not limited to, articulating arms (e.g., robotic arms) to facilitate utilization of the service module 214. In some examples, the drone 200 may include image capturing devices such as, but not limited to, a digital camera. In some examples, the drone 200 may include various navigation electronics such as, but not limited to, radar, GPS, altimeter, pitot tubes, and so forth. Accordingly, the claimed subject matter is not limited in these respects.

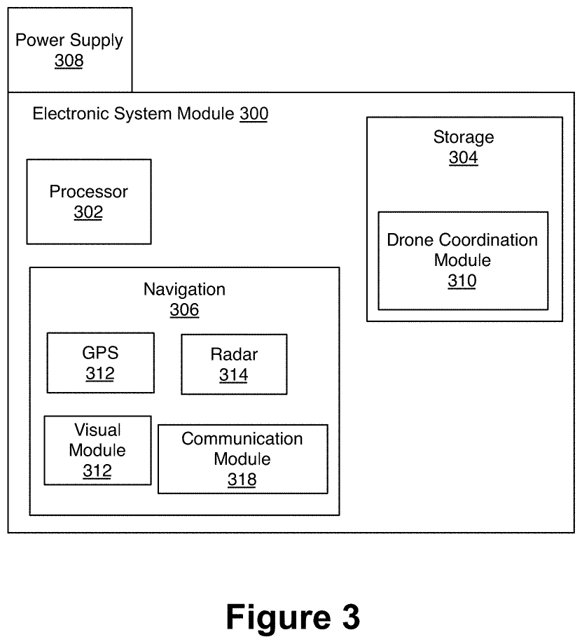

FIG. 3 illustrates an example of an electronic system module, which may be included in a drone, in accordance with various embodiments. In FIG. 3, an electronic system module (ESM) 300 may be illustrated as a block diagram. The ESM 300 may be similar to the electronic system module 216 (shown in FIG. 2) and may be described in further detail. As shown, the ESM 300 may include a processor 302, a storage medium 304, and a navigation module 306. Additionally, the ESM 300 may include a power supply 308. As shown, the processor 302, the storage medium 304, the navigation module 306, and the power supply 308 may all be communicatively coupled to each other. As will be described in more detail, ESM 300, which may be included in a drone (e.g., the drone 200 shown in FIG. 2), may help facilitate coordination of a number of drones, in accordance with various embodiments.

In FIG. 3, the storage medium 304 may include a drone coordination module (DCM) 310. The DCM 310 may comprise of instructions that, when executed by the processor 304, may operatively enable coordination of drones for performing a task and/or service, in accordance with various embodiments. In one example, the DCM 310 may include instructions that may enable the drone 200 (shown in FIG. 2) to facilitate management of a number of drones by executing a supervisor program. In another example, the DCM 310 may include instructions that may help facilitate to determine if the drone 200 (shown in FIG. 2) is fitted with an appropriate service module (e.g., 214 shown in FIG. 2) based, at least in part, on the service to be performed.

In FIG. 3, the navigation module 306 may include various components to help facilitate a drone to autonomously perform a task/service. For example, the navigation module 306 may include a global positioning system (GPS) module 312, a radar module 314, a visual module 316, and a communication module 318. The navigation module may facilitate autonomous operation of a drone to perform a task/service, in accordance with various embodiments. In one example, a number of drones (e.g., the number of drones 104, 106, and 108) may receive various instructions wirelessly to perform a service (e.g., wash windows of a building). The drones may utilize GPS information to fly towards the location of the service to be performed. Once on site (e.g., the building 112), the drones may utilize radar technology to determine their positions relative to the service to be performed (e.g., position/location of the windows 114, 116, 118, and 120). Once completed, the drones and/or the supervisor drone may inspect the windows visually and may transmit the still and/or video images back to the base station (e.g., the base station 101 shown in FIG. 1). Accordingly, a number of drones may be coordinated to perform a task/service autonomously.

In FIG. 3, it should be appreciated that the ESM 300 may comprise of numerous additional components/modules that may not be shown for purposes of describing the disclosed subject matter. For example, the ESM 300 may include a controller for controlling flight such as, but not limited to, a motor controller, a directional controller, etc., and accordingly, the claimed subject matter is not limited in these respects.

It is contemplated that the processor 302 may include a wide variety of processors such as, but not limited to, processors capable of AI type processing. Accordingly, the claimed subject matter is not limited in these respects. Even though the navigation module 306 may include the radar module 314, it is contemplated within the disclosure that the navigation module 306 may include a wide variety of modules that may be utilized to determine various navigation information such as, but not limited to, infrared (e.g., forward looking infrared), synthetic aperture radar (SAR), long range ultrasonic sensors, and so forth. Accordingly, the claimed subject matter is not limited in these respects.

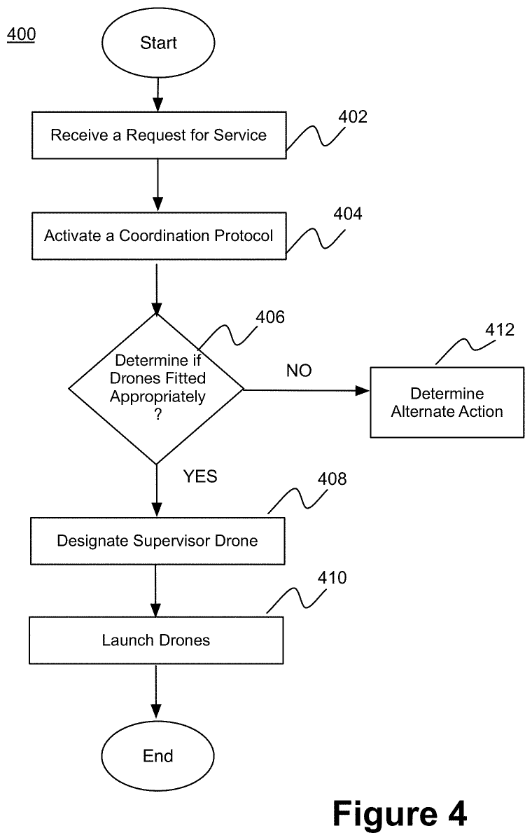

FIG. 4 illustrates an operational flow for coordinating a number of drones to perform a task/service, in accordance with at least some of the embodiments described herein. In some portions of the description, illustrative implementations of the method are described with reference to the system 100 depicted in FIG. 1. However, the described embodiments are not limited to these depictions. More specifically, some elements depicted in FIG. 1 may be omitted from some implementations of the methods detailed herein. Furthermore, other elements not depicted in FIG. 1 may be used to implement example methods detailed herein.

Additionally, FIG. 4 employs block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated. In some examples, the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of claimed subject matter.

In some examples, operational flow 400 may be employed as part of coordinating a number of drones to perform a task/service. Beginning at block 402 (“Receive a Request Service”), the DCM 310 may receive a request for a service to be performed a number of drones. In one example, the service to be performed may be to wash the windows of a building.

Continuing from block 402 to 404 (“Activate a Coordination Protocol”), in response to the received request, the DCM 310 may activate a coordination protocol for the drones based, at least in part, on the service to be performed by the drones.

Continuing from block 404 to decision block 406 (“Determine if the Drones are Fitted Appropriately”), as part of the coordination protocol, the DCM 310 may determine if each of the drones are fitted with an appropriate service module 214 based, at least in part, on the service to be performed. The appropriate service module may be configured to be utilized for the service to be performed. In one example, the service module 214 may include window washing material, as previously described.

Continuing from block 406 to 408 (“Designate Supervisor Drone”), if it is determined that the drones are appropriately fitted with the appropriate service module 214, under the control of the DCM 310, one of the drones may execute a supervisor program to be designated as a supervisor drone with the supervisor program being configured to facilitate management of the rest of the drones during the performance of the service.

Continuing from block 408 to 410 (“Launch the Drones”), under the control of the DCM 310, the drones may be launched towards a direction of the service to be performed with the direction being determined by navigation module 306.

If at decision block 406, it is determined that the drones are not fitted with the appropriate service module, the operation may continue from decision block to 406 to operational block 412 (“Determine Alternate Action”). In one example, the DCM 310 may transmit the received request for the service to an alternate drone base. In another example, the DCM 310 may transmit a request to changeout the current service module from each of the drones to an appropriate service module.

As previously described, in some embodiments, DCM 310 may receive a request for a service of washing windows of a building, and in one example, the building may be a high-rise building. It is contemplated within the subject matter of the present disclosure that the service may including a wide variety of task/service such as but not limited to, landscaping (e.g., lawncare), search and rescue, structural inspection, and so forth. Accordingly, the claimed subject matter is not limited in these respects.

In some embodiments, the DCM 310 may facilitate performance of a self-diagnostic check such as, but not limited to a battery level, a mechanical check, an electronic check, and any combination thereof. The self-diagnostic check may include an overall system check to confirm that the drone may be in a condition to perform the task/service. Along these lines, the DCM 310 may facilitate designation of execution of the supervisor program based, at least in part, on the results of the self-diagnostic check. In one example, the DCM may transmit instructions (e.g., a message) to execute the supervisor program to a drone having an optimum system such as, but not limited to, low hours of operation, highest battery level, most recent mechanical service, newer model, etc. In some embodiments, the supervisor program may facilitate confirming that the service is to a predetermined level (e.g., all windows cleaned, no debris left behind, etc.).

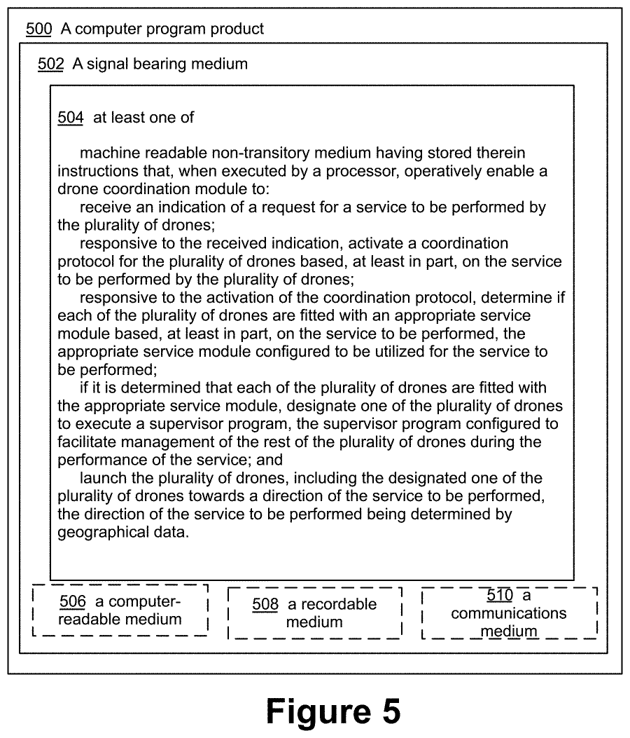

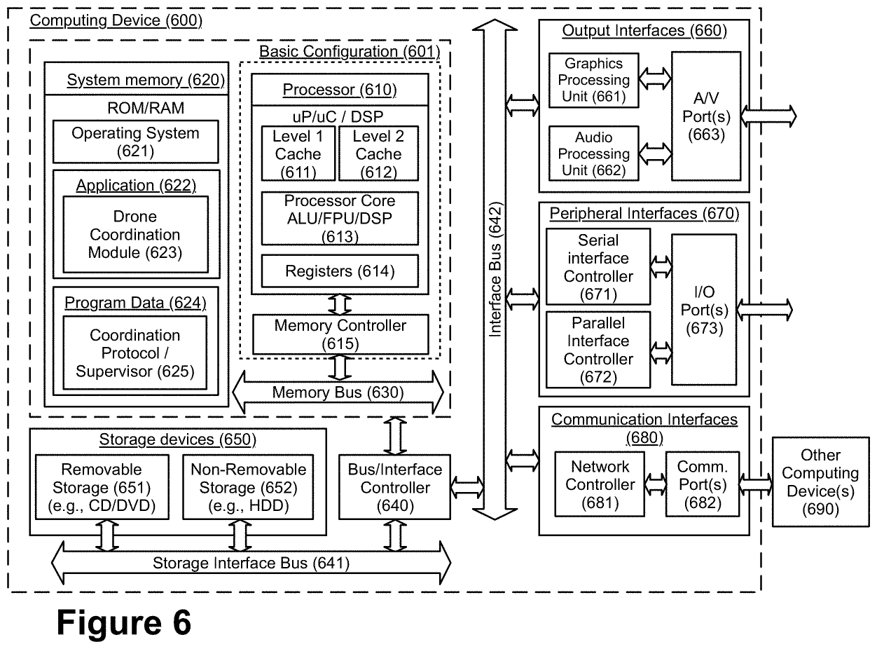

In general, the operational flow described with respect to FIG. 4 and elsewhere herein may be implemented as a computer program product, executable on any suitable computing system, or the like. For example, a computer program product for coordinating a number of drones may be provided. Example computer program products are described with respect to FIG. 5 and elsewhere herein.

FIG. 5 illustrates an example computer program product 500, arranged in accordance with at least some embodiments described herein. Computer program product 500 may include machine readable non-transitory medium having stored therein instructions that, when executed, cause the machine to coordinate a number of drones according to the processes and methods discussed herein. Computer program product 500 may include a signal bearing medium 502. Signal bearing medium 502 may include one or more machine-readable instructions 504, which, when executed by one or more processors, may operatively enable a computing device to provide the functionality described herein. In various examples, some or all of the machine-readable instructions may be used by the devices discussed herein.

In some examples, the machine readable instructions 504 may include receiving an indication of a request for a service to be performed by a number of drones. Responsive to the received indication, the machine readable instructions 504 may include activating a coordination protocol for the drones based, at least in part, on the service to be performed by the drones. Responsive to the activation of the coordination protocol, the machine readable instructions 504 may include determining if each of the plurality of drones are fitted with an appropriate service module based, at least in part, on the service to be performed, the appropriate service module configured to be utilized for the service to be performed. If it is determined that each of the plurality of drones are fitted with the appropriate service module, the machine readable instructions 504 may include designating one of the plurality of drones to execute a supervisor program, the supervisor program configured to facilitate management of the rest of the plurality of drones during the performance of the service. The machine readable instructions 504 may include launching the plurality of drones, including the designated one of the plurality of drones towards a direction of the service to be performed, the direction of the service to be performed being determined by geographical data.

In some implementations, signal bearing medium 502 may encompass a computer-readable medium 506, such as, but not limited to, a hard disk drive, a Compact Disc (CD), a Digital Versatile Disk (DVD), a digital tape, memory, etc. In some implementations, the signal bearing medium 502 may encompass a recordable medium 508, such as, but not limited to, memory, read/write (R/W) CDs, R/W DVDs, etc. In some implementations, the signal bearing medium 502 may encompass a communications medium 510, such as, but not limited to, a digital and/or an analog communication medium (e.g., a fiber optic cable, a waveguide, a wired communication link, a wireless communication link, etc.). In some examples, the signal bearing medium 502 may encompass a machine readable non-transitory medium.

In general, the methods described with respect to FIG. 4 and elsewhere herein may be implemented in any suitable computing system and/or interactive electronic game. Example systems may be described with respect to FIG. 6 and elsewhere herein. In general, the system may be configured to coordinate a number of drones for a task/service to be performed.

FIG. 6 is a block diagram illustrating an example computing device 600, arranged in accordance with at least some embodiments described herein. In various examples, computing device 600 may be configured to coordinate a number of drones for a task/service to be performed as discussed herein. In one example of a basic configuration 601, computing device 600 may include one or more processors 610 and a system memory 620. A memory bus 630 can be used for communicating between the one or more processors 610 and the system memory 620.

Depending on the desired configuration, the one or more processors 610 may be of any type including but not limited to a microprocessor (μP), a microcontroller (μC), a digital signal processor (DSP), or any combination thereof. Additionally, the microprocessors may include Al capable processors such as those previously mentioned. The one or more processors 610 may include one or more levels of caching, such as a level one cache 611 and a level two cache 612, a processor core 613, and registers 614. The processor core 613 can include an arithmetic logic unit (ALU), a floating point unit (FPU), a digital signal processing core (DSP Core), or any combination thereof. A memory controller 615 can also be used with the one or more processors 610, or in some implementations the memory controller 615 can be an internal part of the processor 610.

Depending on the desired configuration, the system memory 620 may be of any type including but not limited to volatile memory (such as RAM), non-volatile memory (such as ROM, flash memory, etc.) or any combination thereof. The system memory 620 may include an operating system 621, one or more applications 622, and program data 624. The one or more applications 622 may include drone coordination module application 623 that can be arranged to perform the functions, actions, and/or operations as described herein including the functional blocks, actions, and/or operations described herein. The program data 624 may include coordination protocol and/or supervisor data 625 for use with the drone coordination module application 623. In some example embodiments, the one or more applications 622 may be arranged to operate with the program data 624 on the operating system 621. This described basic configuration 601 is illustrated in FIG. 6 by those components within dashed line.

Computing device 600 may have additional features or functionality, and additional interfaces to facilitate communications between the basic configuration 601 and any required devices and interfaces. For example, a bus/interface controller 640 may be used to facilitate communications between the basic configuration 601 and one or more data storage devices 650 via a storage interface bus 641. The one or more data storage devices 650 may be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 620, the removable storage 651 and the non-removable storage 652 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 642 for facilitating communication from various interface devices (e.g., output interfaces, peripheral interfaces, and communication interfaces) to the basic configuration 601 via the bus/interface controller 640. Example output interfaces 660 may include a graphics processing unit 661 and an audio processing unit 662, which may be configured to communicate to various external devices such as a display or speakers via one or more A/V ports 663. Example peripheral interfaces 670 may include a serial interface controller 671 or a parallel interface controller 672, which may be configured to communicate with external devices such as input devices (e.g., keyboard, mouse, pen, voice input device, touch input device, etc.) or other peripheral devices (e.g., printer, scanner, etc.) via one or more I/O ports 673. An example communication interface 680 includes a network controller 681, which may be arranged to facilitate communications with one or more other computing devices 683 over a network communication via one or more communication ports 682. A communication connection is one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 600 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. The computing device 600 may also be implemented as a personal computer including both laptop computer and non-laptop computer configurations. In addition, the computing device 600 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to subject matter containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method for coordinating a plurality of drones comprising:
receiving an indication of a request for a service to be performed by the plurality of drones;
responsive to the received indication, activating a coordination protocol for the plurality of drones based, at least in part, on the service to be performed by the plurality of drones;
responsive to the activation of the coordination protocol, determining if each of the plurality of drones are fitted with an appropriate service module based, at least in part, on the service to be performed, the appropriate service module configured to be utilized for the service to be performed;
if it is determined that each of the plurality of drones are fitted with the appropriate service module, designating one of the plurality of drones to execute a supervisor program, the supervisor program configured to facilitate management of the rest of the plurality of drones during the performance of the service; and
launching the plurality of drones, including the designated one of the plurality of drones towards a direction of the service to be performed, the direction of the service to be performed being determined by geographical data.

2. The method of claim 1, wherein the receiving the indication comprises receiving the indication at a drone base.

3. The method of claim 1, wherein the request for the service comprises a request for a service of washing windows of a building.

4. The method of claim 3, wherein the request for the service of washing windows of the building comprises a request for a service of washing windows of a high-rise building.

5. The method of claim 1, wherein activating a coordination protocol comprises broadcasting a wireless communication message to the plurality of drones.

6. The method of claim 1, wherein determining if each of the plurality of drones are fitted with the appropriate service module comprises each of the plurality of drones performing a self-diagnostic check, the self-diagnostic check including one or more of a battery level check, a mechanical check, or an electronic system check.

7. The method of claim 1, wherein designating one of the plurality of drones to execute the supervisor program comprises wirelessly transmitting a message to the designated one of the plurality of drones, the message having instructions to execute a stored executable program.

8. The method of claim 1, wherein the supervisor program is further configured to facilitate that the performance of the service is to a predetermined level.

9. The method of claim 1, wherein if it is determined that each of the plurality of drones are not fitted with the appropriate service module, transmitting the received indication of the request for the service to be performed to an alternate drone base.

10. The method of claim 1, wherein if it is determined that each of the plurality of drones are not fitted with the appropriate service module, transmitting a request to changeout a current service module from each of the plurality of drones to an appropriate service module.

11. A machine readable non-transitory medium having stored therein instructions that, when executed by one or more processors, operatively enable a drone coordination module (DCM) to receive an indication of a request for a service to be performed by the plurality of drones, responsive to the received indication, activate a coordination protocol for the plurality of drones based, at least in part, on the service to be performed by the plurality of drones, responsive to the activation of the coordination protocol, determine if each of the plurality of drones are fitted with an appropriate service module based, at least in part, on the service to be performed, the appropriate service module configured to be utilized for the service to be performed, if it is determined that each of the plurality of drones are fitted with the appropriate service module, designate one of the plurality of drones to execute a supervisor program, the supervisor program configured to facilitate management of the rest of the plurality of drones during the performance of the service, and launch the plurality of drones, including the designated one of the plurality of drones towards a direction of the service to be performed, the direction of the service to be performed being determined by geographical data.

12. The machine readable non-transitory medium of claim 11, wherein the stored instructions that, when executed by one or more processors, further operatively enable the DCM to receive the indication at a drone base.

13. The machine readable non-transitory medium of claim 11, wherein the stored instructions that, when executed by one or more processors, further operatively enable the DCM to receive a request for a service of washing windows of a building.

14. The machine readable non-transitory medium of claim 13, wherein the stored instructions that, when executed by one or more processors, further operatively enable the DCM to receive a request for a service of washing windows of a high-rise building.

15. The machine readable non-transitory medium of claim 11, wherein the stored instructions that, when executed by one or more processors, further operatively enable the DCM to broadcast a wireless communication message to the plurality of drones.

16. The machine readable non-transitory medium of claim 11, wherein the stored instructions that, when executed by one or more processors, further operatively enable the DCM to perform a self-diagnostic check of each of the plurality of drones, the self-diagnostic check including one or more of a battery level check, a mechanical check, or an electronic system check.

17. The machine readable non-transitory medium of claim 11, wherein the stored instructions that, when executed by one or more processors, further operatively enable the DCM to wirelessly transmit a message to the designated one of the plurality of drones, the message having instructions to execute a stored executable program.

18. The machine readable non-transitory medium of claim 11, wherein the stored instructions that, when executed by one or more processors, further operatively enable the DCM to facilitate that the performance of the service is to a predetermined level.

19. The machine readable non-transitory medium of claim 11, wherein the stored instructions that, when executed by one or more processors, further operatively enable the DCM to transmit the received indication of the request for the service to be performed to an alternate drone base if it is determined that each of the plurality of drones are not fitted with the appropriate service module.

20. The machine readable non-transitory medium of claim 11, wherein the stored instructions that, when executed by one or more processors, further operatively enable the DCM to transmit a request to changeout a current service module from each of the plurality of drones to an appropriate service module if it is determined that each of the plurality of drones are not fitted with the appropriate service module.

21. A system for coordinating a plurality of drones comprising:
a processor;
a drone communicatively coupled to the processor;
a storage medium communicatively coupled to the processor; and
a drone coordination module (DCM) communicatively coupled to the processor and the storage medium, the DCM configured to receive an indication of a request for a service to be performed by the plurality of drones, responsive to the received indication, activate a coordination protocol for the plurality of drones based, at least in part, on the service to be performed by the plurality of drones, responsive to the activation of the coordination protocol, determine if each of the plurality of drones are fitted with an appropriate service module based, at least in part, on the service to be performed, the appropriate service module configured to be utilized for the service to be performed, if it is determined that each of the plurality of drones are fitted with the appropriate service module, designate one of the plurality of drones to execute a supervisor program, the supervisor program configured to facilitate management of the rest of the plurality of drones during the performance of the service, and launch the plurality of drones, including the designated one of the plurality of drones towards a direction of the service to be performed, the direction of the service to be performed being determined by geographical data.

22. The system of claim 21, wherein the DCM is further configured to operatively enable the DCM to receive the indication at a drone base.

23. The system of claim 21, wherein the DCM is further configured to operatively enable the DCM to receive a request for a service of washing windows of a building.

24. The system of claim 23, wherein the DCM is further configured to operatively enable the DCM to receive a request for a service of washing windows of a high-rise building.

25. The system of claim 21, wherein the DCM is further configured to operatively enable the DCM to broadcast a wireless communication message to the plurality of drones.

26. The system of claim 21, wherein the DCM is further configured to operatively enable the DCM to perform a self-diagnostic check of each of the plurality of drones, the self-diagnostic check including one or more of a battery level check, a mechanical check, or an electronic system check.

27. The system of claim 21, wherein the DCM is further configured to operatively enable the DCM to wirelessly transmit a message to the designated one of the plurality of drones, the message having instructions to execute a stored executable program.

28. The system of claim 21, wherein the DCM is further configured to operatively enable the DCM to facilitate that the performance of the service is to a predetermined level.

29. The system of claim 21, wherein the DCM is further configured to operatively enable the DCM to transmit the received indication of the request for the service to be performed to an alternate drone base if it is determined that each of the plurality of drones are not fitted with the appropriate service module.

30. The system of claim 21, wherein the DCM is further configured to operatively enable the DCM to transmit a request to changeout a current service module from each of the plurality of drones to an appropriate service module if it is determined that each of the plurality of drones are not fitted with the appropriate service module.
